(19) United States
(12) Patent Application Publication
(10) Pub. No.: US 2025/0112469 A1
(43) Pub. Date: Apr. 3, 2025

(54) SOLAR PANEL ARCHITECTURE

(71) Applicant: Pulsiv Limited, Cambridge (GB)

(72) Inventor: Mohammed Zaki Ahmed, Cambridge (GB)

(73) Assignee: Pulsiv Limited, Cambridge (GB)

(21) Appl. No.: 18/833,136

(22) PCT Filed: Jan. 27, 2023
(86) PCT No.: PCT/GB2023/050192

§ 371 Date: Jul. 25, 2024

(30) Foreign Application Priority Data
Jan. 28, 2022 (GB) 2201109.2

(51) Int. Cl. H02J 3/46; H02J 3/00; H02J 3/36; H02S 40/32

(52) U.S. Cl. CPC H02J 3/46; H02J 3/36; H02S 40/32; H02J 3/001; H02J 2300/26

(57) ABSTRACT

An apparatus for use in a solar power plant including a plurality of photovoltaic panels, wherein the apparatus includes a plurality of power conditioning units adapted to collect DC power at a panel voltage from the photovoltaic panels, and to pass the DC power to an intermediate power transfer line, such as cabling, and a common inverter unit adapted to receive the DC power from the power conditioning units through the intermediate power transfer line and to convert the DC power into AC power for output. A corresponding method of operation is described. The apparatus may be used to provide a steady AC power output during periods of low DC power collection.

The invention relates to solar power plants or other collections of photovoltaic panels. Such solar power plants typically comprise a large number of photovoltaic panels distributed over a large area.

### INTRODUCTION

Utility scale solar power plants typically comprise thousands, to hundreds of thousands, of separate photovoltaic panels distributed across large tracts of land, and commercial/industrial scale solar power plants may similarly typically comprise at least hundreds of separate photovoltaic panels.

Suitable photovoltaic panels which are currently used for such installations typically have an area of around 1.0 to 3.0 m2, each comprising around a hundred separate power generating solar cells which in series can generate electricity at around 50 volts. A typical maximum power output of such a photovoltaic panel in strong sunlight might be of the order of 500 W. Efficiencies of conversion from sunlight to electrical power of around 20% can now routinely be delivered, even with single junction silicon technologies.

Under any particular incident light conditions, each photovoltaic cell performs according to a current-voltage relationship which provides a peak in electrical power output at around 70-80% of the open circuit voltage. However, the precise peak power point varies with parameters such as intensity, spectral and polarisation characteristics of the incident sunlight, as well as operational factors such as ambient temperature. Dynamic maximum power point (MPP) control is therefore typically used in order to collect the maximum electrical power from installed solar panels by controlling the collected electrical current.

Additionally, solar photovoltaic panels generate DC power, whereas AC power is usually required for injection into utility grids or for most local industrial or commercial purposes. DC to AC power inverter circuits are therefore used to convert the DC power collected from the photovoltaic panels into AC power.

To collect electrical power from the photovoltaic panels in a solar power plant, a small group of panels may be connected in electrical series to a single string inverter unit, which typically implements both maximum power point control and the inverter function for those panels. Each string inverter unit then outputs an optimised level of AC power at a chosen voltage, often as three phase power, suitable for injection into the local utility grid or for local industrial or commercial use. A typical string inverter unit might be designed for connection to around 5 to 10 photovoltaic panels, and be rated to output a few kW at around 220-240 V (RMS).

However, although the provision of single string inverter for multiple photovoltaic panels in series is efficient in terms of relative simplicity of manufacture, installation and maintenance, the series electrical connection between the panels means that the maximum power point tracking cannot account for any differences in operational characteristics between the series connected panels, which characteristics can change over time due to degradation and build-up of dirt, electrical failure, or due to short or longer term differences in illumination between the several panels. The entire connected string of panels therefore tends to be constrained by the power output of the worst performing panel. If the string inverter fails then the entire string of panels also becomes unoperational until the unit is repaired or replaced.

Solar power plants may therefore instead use a separate microinverter unit located at, and connected to, each photovoltaic panel, the microinverter carrying out both maximum power point control and inversion from DC to AC power at the associated panel. Such microinverters may be more expensive to manufacture and install than the equivalent required string inverters, but can provide superior overall power output through power optimisation of each panel separately, and degradation or failure of one panel or one microinverter unit will have a smaller effect on overall power output than if a string inverter was used and degraded or failed in a similar manner.

Especially at utility scales, achieving an optimal balance between overall efficiency of light conversion to useful electrical power, cost of the power handling infrastructure including string inverters or microinverters and related cabling, and the cost of maintenance and repair, is a complex problem. The invention seeks to address these and other difficulties of the related prior art.

### SUMMARY OF THE INVENTION

Embodiments of the invention seek to combine benefits of string inverter and microinverter architectures into a single system suitable for use in a solar power plant or similar system comprising photovoltaic panels, and to minimise power losses in cables carrying power from the photovoltaic panels.

Accordingly, the invention provides apparatus for use in a solar power plant or other system comprising a plurality of photovoltaic panels, the apparatus comprising a plurality of power conditioning units, each power conditioning unit being adapted to collect DC power at a panel voltage from each of one or more photovoltaic panels associated with the power conditioning unit, and to pass the DC power to an intermediate power transfer line, such as cabling; and a common inverter unit adapted to receive the DC power from the plurality of power conditioning units through the intermediate power transfer line, and to convert the DC power into AC power for output, for example for export, which could be exported to a utility, local, or other AC power grid or distribution system.

The invention also provides a solar power plant, or other system, comprising the above apparatus, the one or more photovoltaic panels associated with each power conditioning unit, and typically also the intermediate power transfer line.

All of the power conditioning units may be connected electrically in parallel to the common inverter unit through the intermediate power transfer line. As will be appreciated, the intermediate power transfer line may be constituted by intermediate cabling, or other suitable connection arrangement for power transfer, such as an intermediate bus bar arrangement. As will be appreciated, different transfer line types may be used and combined in an installation.

Typically, each photovoltaic panel may have an active photovoltaic surface area of at least one square meter, and/or be rated to generate at least 100 W of electrical power.

Each power conditioning unit may comprise a converter, such as a boost converter, flyback converter, push-pull converter, forward converter, or other apparatus arranged to raise the voltage of the collected DC power to a higher level for transmission across the intermediate power transfer line. This higher voltage may for example be above the peak voltage of the AC power for output, and may also be above the panel voltage of any or all of the associated photovoltaic panels. The higher voltage DC power may in particular be at the same or substantially the same voltage for all of the intermediate power transfer line, and all of the power conditioning units, noting the parallel electrical connections which may be used between the power conditioning units to the common inverter.

The high voltage DC power may be at a variable voltage level depending on operational conditions, but typically may have a voltage of at least 350 V, or at least 400 V, at least when the common inverter unit is outputting or exporting AC power. In this way, power losses in the cabling and/or connector links and the like can be reduced considerably while consolidating the inverter functionality for a plurality of panels in a single common inverter unit.

Moreover, the voltage level of the high voltage DC power may be used to signal operational conditions to various parts of the apparatus or system to implement suitable control measures, for example if the system is arranged such that the voltage of the high voltage DC power is dependent upon one or both of: a concurrent demand for AC power for output or export; and concurrently collected DC power from the plurality of photovoltaic panels.

The apparatus may further comprise an energy storage unit coupled to each power conditioning unit, the power conditioning unit being arranged to selectively store at least a portion of the collected DC power, and to selectively release at least a portion of the stored energy from that DC power to the common inverter unit through the intermediate power transfer line. Conveniently, the storage of the DC power by the energy storage unit may be substantially at, or within the working range of the high voltage DC power.

Selective storing of at least a portion of the collected DC power may conveniently be controlled at the power conditioning unit dependent, at least in part, on the voltage of the high voltage DC power.

Each power conditioning unit may be arranged to condition the collected DC power using maximum power point tracking to control the panel voltage and/or the output current of each of the associated one or more photovoltaic panels.

The average length of an intermediate power transfer line in the form of cabling between each of the power conditioning units and the common inverter unit may be at least 5 metres, or at least 10 metres, or at least 20 metres. The average length of intermediate power-transfer bus bar systems may differ according to link dimensions. The number of power conditioning units passing high voltage DC power to the common inverter unit through the intermediate cabling may be at least ten, and the common inverter unit may be so adapted. Each power conditioning unit may be associated with a limited number of photovoltaic panels, for example with no more than four photovoltaic panels, or with only one photovoltaic panel, and each power conditioning unit may be so adapted.

Each power conditioning unit may be one of: incorporated within, mounted to, or located within 3 metres or within 5 metres of the associated photovoltaic panel, or of one of the associated photovoltaic panels if there are more than one.

The common inverter unit may comprise a plurality of separate inverter circuits, each inverter circuit being arranged to receive at least portion of the DC power from the intermediate power transfer line and to convert the received portion of DC power into AC power for output or export. The common inverter unit may then be arranged to selectively activate or inactivate one or more of the inverter circuits.

This enables the common inverter unit to operate at improved levels of power conversion efficiency over a range of levels of outputted or exported AC power. For example, at least two of the inverter circuits may have different efficiency characteristics from each other with respect to the amount of power being converted, and the common inverter unit may then be arranged to selectively activate and inactivate different ones of the inverter circuits according to the different efficiency characteristics of those inverter circuits and a demand characteristic such as detected current demand for AC power output or export by the connected power grid.

The inverter circuits can often be the most likely part of the system to fail. To address this, the common inverter unit may be arranged to detect a faulty or compromised one of the inverter circuits and then automatically to avoid selection of that faulty or compromised inverter circuit for conversion of the DC power into AC power for output or export. The common inverter circuit may also generate an alarm or warning signal, which may be communicated to an operator for example over a data network, to indicate the identity of the faulty or compromised inverter circuit.

To improve reliability of the or each common inverter unit as a whole, a common inverter unit may also or instead be arranged to maintain a measure of reliability of one or more of its inverter circuits, and to selectively limit or reduce power loading of these inverter circuits according to the measure of reliability. The measure of reliability could be based on various factors such as manufacturer's tests, age, total power conversion to date, concurrently measured temperature, and so forth.

The common inverter unit may be particularly arranged to permit any one of the inverter circuits to be removed and replaced without disconnecting the other inverter circuits, for example in a hot-swappable arrangement where this can be done without suspending operation of the other inverter circuits.

The invention also provides methods of building and methods of operating the described apparatus, individual components of that apparatus, or a solar power plant or other system comprising the apparatus as described above. Such a method may comprise, for example, at each of a plurality of power conditioning units, receiving collected DC power from one or more photovoltaic panels, each power conditioning unit being arranged to collect DC power at a panel voltage and to pass the DC power to intermediate power transfer line; transmitting the DC power from each of the power conditioning units, through the intermediate power transfer line, to a common inverter unit; and at the common inverter unit, converting the DC power into AC power with a peak voltage, for output or export to a power grid.

The method may further comprise, at each power conditioning unit, raising the voltage of the collected DC power to a higher DC voltage, which is above the panel voltage and below the peak voltage for transmission through the intermediate power transfer line. For example, the panel voltage may be below 100 V and the higher DC voltage may be at least 350 V, or at least 400 V, at least at a time when the common inverter unit is outputting AC power to the grid. The level of the higher DC voltage may be at least partly dependent upon one or both of: a concurrent demand for AC power for output to the power grid; and concurrently collected DC power from the one or more photovoltaic panels.

The method may further comprise selectively storing at least a portion of the collected DC power, or selectively releasing at least a portion of the collected DC power so stored to the common inverter unit, the storing and releasing being controlled dependent on the level of the higher DC voltage.

In some variations of the described apparatus and methods, the power conditioning units may receive AC power instead of DC power from the photovoltaic panels. In other variations, the photovoltaic panels may be replaced by different power generating devices such as wind or water driven turbines, which may provide either DC power or AC power to be collected by the power conditioning units.

### BRIEF SUMMARY OF THE DRAWINGS

Embodiments of the invention will now be described, by way of example only, with reference to the accompanying drawings of which:

FIG. 1 illustrates a solar power plant or similar system, and how a plurality of photovoltaic panels of the solar power plant, each having one or more associated power conditioning units, may be connected to a common inverter unit for providing AC power for output or export;

FIG. 2 shows in more detail aspects of the power conditioning units and of the common inverter unit of FIG. 1; and

FIG. 3 illustrates how the solar power plant or similar system of FIGS. 1 and 2 may operate with respect to the level of the voltage of the high voltage DC power carried by the intermediate cabling between the power conditioning units and the common inverter unit.

### DETAILED DESCRIPTION OF EMBODIMENTS

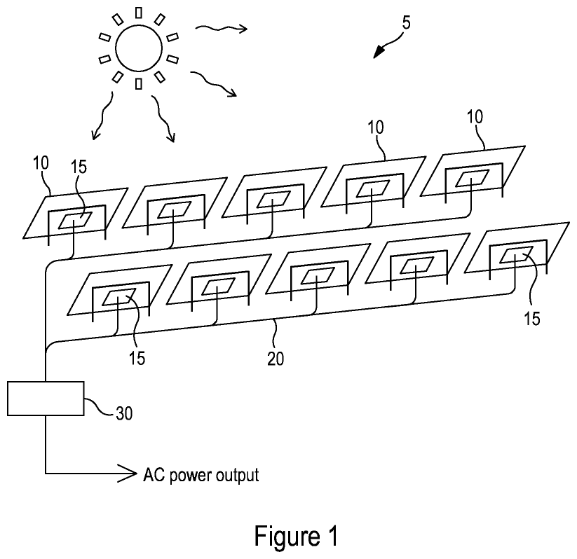

Referring to FIG. 1 there is illustrated a solar power plant 5 comprising a plurality of photovoltaic panels 10. These may typically be mounted on frames, optionally moveable to track the sun in some way, and are typically distributed across large tracts of land, although they may be mounted on buildings or other structures, on bodies of water and so forth. A typical solar power plant 5 may comprise hundreds, to hundreds of thousands, of such photovoltaic panels 10. Each such photovoltaic panel 10 might have an active area of around 1.0 to 3.0 m2 and be rated to generate at least 100 W, or in the region of 500 W, in strong sunlight. Each photovoltaic panel may be arranged to generate electricity at a voltage of at least 10 V, or more typically in the region of 50 V, with an entire solar plant therefore being capable of generating between about 50 kW to about 100 MW or more. However, the invention is also applicable to smaller scale solar power plants for example with at least ten photovoltaic panels each rated to generate at least 100 W in strong sunlight.

The solar power plant also comprises a plurality of power conditioning units 15. Each power conditioning unit 15 is associated with one or more of the photovoltaic panels 10. In FIG. 1, each power conditioning unit 15 is associated with just one of the photovoltaic panels 10, but could be associated with up to four, or potentially more, of the panels. In FIG. 1, each power conditioning unit 15 is mounted to its associated photovoltaic panel, but could instead be incorporated within its associated panel, or located proximally to the panel for example within 5 metres of the panel.

Each power conditioning unit 15 is arranged to collect DC power from the associated one or more photovoltaic panels 10, and to forward that DC power through intermediate electrical power cabling 20 to a common inverter unit 30. The common inverter unit 30 is then arranged to convert the DC power into AC power for output or export, for example for output to a major utility grid, or to a more local power supply system within a commercial, industrial, or other context. Typically, the common inverter unit 30 may output AC power at 220-240V (RMS) AC, or higher voltages if required, and may output single phase or three phase power for example. The solar power plant 5 may include many such groups of common inverter unit 30 and power conditioning units 15 feeding into that common inverter unit, for example from tens, to tens of thousands of such groups.

One common inverter unit 30 may receive DC power from at least several power conditioning units 15, say from five or from ten or more such units, and therefore from the same or a larger number of photovoltaic panels 10. Given the typical size of photovoltaic panels 10 used in solar power plants, of at least 1.0 m2 or so, and the need for these to be arranged to avoid mutual sunlight shadowing, the average length of the intermediate cabling 20 from each of the power conditioning units 15 to the common inverter unit 30 may be considerable, for example at least five metres, at least ten metres, or at least twenty metres. The intermediate cabling 20 from each power conditioning unit 15 to the common inverter unit 30 may be separate to that from other power conditioning units, or portions of such cabling may be shared by virtue of suitable electrical connections or junctions within the intermediate cabling 20. In particular, the intermediate cabling 20 may be arranged such that all of the power conditioning units are connected electrically in parallel to the common inverter unit 30. Herein, the cabling 20 constitutes one form of an intermediate power-transfer line. In some embodiments, the power transfer line may be provided by, or comprise, other means such as bus bar arrangements or other suitable connections.

To reduce power losses in the intermediate cabling 20, each power conditioning unit 15 is therefore arranged to raise the voltage of the DC power to a higher, or high voltage DC for transmission to the common inverter unit through the intermediate cabling. Typically, this high voltage may be variable depending on the DC power which can be collected from the photovoltaic panels at any particular time, and the concurrent demand for AC power output by the common inverter unit. However, during operation of the plant, and at least when a common inverter unit 30 is outputting AC power, this high voltage will be both above the peak voltage of the AC power for output by the common inverter unit (for example about 310-340 V for AC with RMS voltage of 220-240 V), and also above the voltage of the DC power being collected from the photovoltaic panels by the power conditioning units, which may be referred to as the panel voltage.

The voltage of the high voltage DC provided by all the power conditioning units may be the same, as will be the case if all of the power conditioning units are connected in common to a same portion of the intermediate cabling, or more particularly connected electrically in parallel to the common inverter unit 30. Such arrangements may also have the advantage of simplifying the intermediate cabling 20 and the common inverter unit 30. The panel voltage of each separate photovoltaic panel may differ slightly, for example depending on performance and control of each panel, but the high voltage DC may then be above the average or above the highest of these panel voltages. Typically, the panel voltage may be around 50 V. The voltage of the high voltage DC may typically be at least 350 V, or at least 400 V, for example being set at approximately 450 V or 900 V, or for example in an operational range of 420 to 460 V.

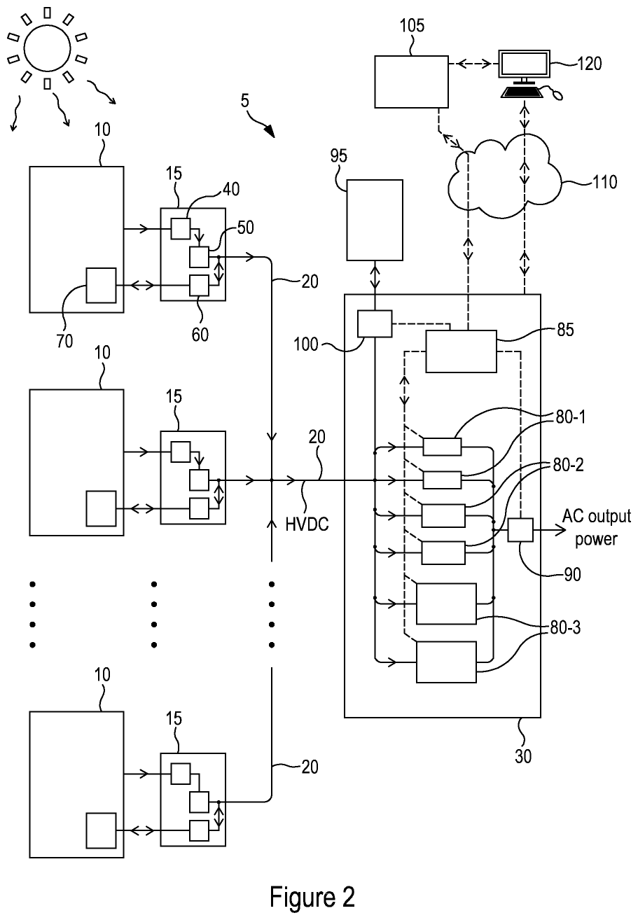

FIG. 2 schematically shows in more detail how aspects of the solar power plant 5 of FIG. 1 may be implemented. Each power conditioning unit 15 is connected to one or more associated photovoltaic panels 10 (connected to just one in the specific implementation of FIG. 2) to collect DC power from the panel, and to the intermediate cabling 20 for transmission of the DC power to the common inverter unit 30, such that all of the power conditioning units are connected electrically in parallel to the common inverter unit 30.

In order to extract an improved or maximum amount of DC power from the associated photovoltaic panel 10, each power conditioning unit 15 comprises a maximum power point tracker 40. The maximum power point tracker 40 may be implemented in electrical circuitry alone, or in electrical circuitry in combination with computer software. Some examples of how such maximum power point tracking may be implemented are provided in K. H. Hussein, I. Muta, T. Hshino, M. Osakada: “Maximum photovoltaic power tracking: an algorithm for rapidly changing atmospheric conditions”, IEE Proceedings-Generation, Transmission and Distribution, Vol.142, Issue 1, January 1995, pp. 59-64.

Sensing and control of the current and/or voltage from the photovoltaic panel 10 by the maximum power point tracker 40 in order to keep the collected DC power at or very close to the maximum power point for the panel may operate on timescales of just a few milliseconds, with perturbations in panel voltage occurring at fast rates of around 2 to 5 kHz at higher levels of collected DC power for example above about 150 W, and typically at increasingly lower rates down to around 100 Hz for lower extracted power of, say, 20 W.

Each power conditioning unit 15 also comprises a DC/DC converter 50 which increases the voltage of the collected DC power to a higher voltage DC power which is passed to the intermediate cabling 20. The converter 50 may use an isolated or non-isolated design and may be implemented in various ways, for example using boost converter, flyback converter, push-pull converter, or forward converter designs, for which see relevant chapters in the “Power Topologies Handbook” by Markus Zehendner and Matthias Ulmann, Texas Instruments Incorporated, 2016, found at https://www.ti.com/seclit/ug/slyu036/slyu036.pdf. The converter 50 raises the voltage of the collected DC power from the panel voltage of the collected power output by the maximum power point tracker 40, typically around 50 V, to a voltage which is higher than the panel voltage, and higher than the peak voltage output by the common inverter unit 30. This higher voltage may for example be at least 350 V, or at least 400 V, for example around 450 V or 900 V. Typically, as mentioned above, this higher voltage level will also change in response to available DC power from the panel, demand for AC power output, and any power storage which is active or available.

Each power conditioning unit 15 may also comprise an energy storage switch 60 which is arranged to selectively direct at least a portion of the collected DC power to a corresponding or associated energy storage unit 70, and to selectively release at least a portion of the stored DC power from the corresponding energy storage unit 70 to the common inverter unit 30 through the intermediate cabling, at appropriate times. The energy storage switch 60 is preferably connected to the high voltage DC power that has been output by the converter 50, so that the DC power is stored in the energy storage unit 70 at substantially the voltage of the high voltage DC power.

Whether, at any particular time, the energy storage switch 60 operates to store or release the collected DC power, may be controlled in various ways. However, in some embodiments the energy storage switch 60 acts to store DC power in the energy storage unit 70 when the high voltage DC power is at a higher voltage level, and to release DC power to the common inverter unit 30 when the high voltage DC power is at a lower voltage level, for example when the high voltage DC power is above or below a particular voltage threshold, above a first threshold or below a second threshold, or according to some other function. The high voltage DC power may then be used to indicate to the energy storage switch the current balance of demand for AC power for output by the common inverter unit and availability of DC power for collection from the photovoltaic panel.

In this way, the power conditioning units 15 may operate with the energy storage units 70 to reduce the effects of significant and/or or rapid changes in power output by the associated photovoltaic panels, such as when passing clouds shade the sun. Drops in panel power output can immediately be compensated by the drawing of power from the energy storage units 70 which can either enable the power conditioning units to continue to provide the immediately preceding level of power to the common inverter unit for a period of time, or provide a gradually diminishing level of power to assist in smoothing variations in the level of power provided.

The energy storage units 70 may be implemented in various ways, for example using a bank of one or more electrical capacitors or using a bank of one or more chemical battery cells such as lithium ion cells. The energy storage unit 70 could be located within or coupled to the power conditioning unit 15, within or coupled to the associated photovoltaic panel 10, or nearby the power conditioning unit and/or panel. One or more such energy storage units may be coupled to each power conditioning unit, or one or more such energy storage units may be shared between two or more power conditioning units.

The common inverter unit 30 receives the high voltage DC power through the intermediate cabling, and converts this to AC power for output to a utility or local power grid. To this end, the common inverter unit may comprise a plurality of separate inverter circuits 80-1, 80-2, 80-3. In FIG. 2 six such inverter circuits are shown, but fewer or more may be used.

At least two of the inverter circuits may have different efficiency characteristics than each other, and with respect to the amount of power being converted. Typically, each inverter circuit will have an efficiency curve with a peak efficiency at a power level somewhat lower than the maximum power level for that circuit. To this end, a first group of one or more inverter circuits 80-1 may be designed to be most efficient at some lower levels of power conversion, for example at up to about 20 W for each circuit, a second group of one or more inverter circuits 80-2 may be designed to be most efficient at intermediate levels of power conversion, for example from about 20 W up to about 80 W for each circuit, and a third group of one or more inverter circuits 80-3 may be designed to be most efficient at higher levels of power conversion, for example from about 80 W up to 300 W for each circuit.

An inverter control unit 85 provided in the common inverter unit 30 is then arranged to selectively activate and deactivate, and/or control the duty cycle or other level of operation of each of the inverter circuits 80-1 . . . 80-3 in order to increase or optimise the overall efficiency of the common inverter unit 30 in converting the high voltage DC power to the AC power for output. As will be appreciated, in this manner any appropriate number of appropriately dimensioned inverter circuits can be selected or deselected to achieve a desired power conversion and output. The ability to deselect inverter circuits increases the system's resilience to faulty or otherwise unavailable inverter circuits.

The common inverter unit 30 may comprise a grid detector 90 arranged to detect a state of the utility or other power grid to which the AC power is being delivered by the common inverter unit 30. The common inverter unit 30 may also or instead receive requests or instructions, from an operator 105 of the utility or other power grid for example over a data network 110, to control the amount of AC power being delivered by the common inverter unit 30, and the common inverter unit 30 may then be adapted to implement such requests of instructions. For example, the operator 105 may request that the amount of AC power being output is fixed at a certain value, reduced, kept below a certain level, increased, or kept above a certain level.

If the grid detector 90 detects that the power grid is in oversupply, or a request is received from the operator 105 to reduce supply, the inverter control unit 85 can select the most appropriate reduced subset of inverter circuits in order to provide less output AC power. If the grid detector 90 detects that the power grid is in undersupply, or a request is received from the operator 105 to increase supply, the inverter control unit 85 can select the most appropriate increased subset of inverter circuits in order to provide more output AC power.

Using these and/or other techniques, the inverter control unit 85 can increase or decrease the amount of AC power delivered by the common inverter unit to the AC power output, both in response to the output of the grid detector and/or in response to operator requests, and in response to the available DC power for collection from the photovoltaic panels. Note that, although the inverter control unit 85 in FIG. 2 is depicted as a single element separate from each of the inverter circuits, the same functionality may instead be provided entirely or partly within the inverter circuits themselves.

The state of the power grid may be detected by the grid detector 90 for example by comparing the phase of the AC power on the power grid to an internally created sinusoidal reference signal. Typically, an earlier phase of the power grid may indicate oversupply, and a later phase of the power grid may indicate undersupply. The power conditioning units and common inverter unit may be arranged such that, if the concurrent demand for AC power output exceeds that being collected from the photovoltaic panels, then the voltage of the high voltage DC will fall, and if the concurrent power being collected from the photovoltaic panels exceeds the demand for AC power output, then the voltage of the high voltage DC will rise. The voltage of the high voltage DC may therefore be used as an indicator for any or all of the various power control and storage functions of the power conditioning units and the common inverter unit.

For example, as well as providing energy storage units at each of the power conditioning units, a further energy storage unit 95 may be provided in, at, or proximal to the common inverter unit 30, with the amount of high voltage DC power diverted to or recovered from the further energy storage unit 95 being controlled by a further energy storage switch 100 of the common inverter unit 30.

As well as or instead of selectively activating, deactivating or otherwise controlling each of the inverter circuits to maximise efficiency of power conversion, and/or to match the concurrent demand for output AC power, the inverter control unit 85 may activate, deactivate or otherwise control the inverter circuits 80-1 . . . 80-3 for other purposes or according to other design features or current performance characteristics of the inverter circuits. For example, the inverter control unit 85 may be arranged to detect a faulty one of the inverter circuits and subsequently avoid selection of that faulty inverter circuit for conversion of the DC power into AC power for output, or to detect one or more of the inverter circuits with reduced levels of efficiency or some level of degradation, and to reduce usage of those faulty or degraded inverter circuits accordingly.

Similarly, the inverter control unit 85 may maintain a measure of reliability of some or all of the inverter circuits 80-1 . . . 80-3, and may then control the power loading or level of power conversion by each inverter circuit accordingly, for example to reduce or limit the power loading of inverter circuits with a lower measure of reliability. In this way, an inverter circuit with a lower measure of reliability may be operated at lower levels of power conversion in order to extend the lifetime of the inverter circuit and improve the reliability of the common inverter unit as a whole. Such measures of reliability could for example be based on, or utilise, a prior known reliability of an inverter circuit when installed (for example based on standard manufacturers tests, known build quality, etc.), on age (for example total operation time since installation), on total power conversion to date, and/or similar measures.

The use of multiple separate inverter circuits 80-1 . . . 80-3 in the common inverter unit 30 also allows for more convenient and cost-effective maintenance, since just one faulty inverter circuit can be removed, repaired or replaced without interfering with the remaining inverter circuits. To this end, the common inverter unit 30 may be designed to allow easy or “plug-and play” removal of a single inverter circuit, for example with each inverter circuit being provided on a separate circuit board in a separate unpluggable unit, and this functionality may be provided in a hot-swappable form such that any one of the inverter circuits may be removed and/or replaced without powering down the common inverter unit 30.

To this end, the inverter control unit 85, and/or other aspects of the common inverter unit 30 may provide data signals over data network 110 to a remote monitor unit 120, which could be provided by a conventional control panel, a personal computer, or other device, in order to signal operational aspects of the common inverter unit, for example failure or reduced performance of one of the inverter circuits, so that maintenance staff can undertake repairs or replacement.

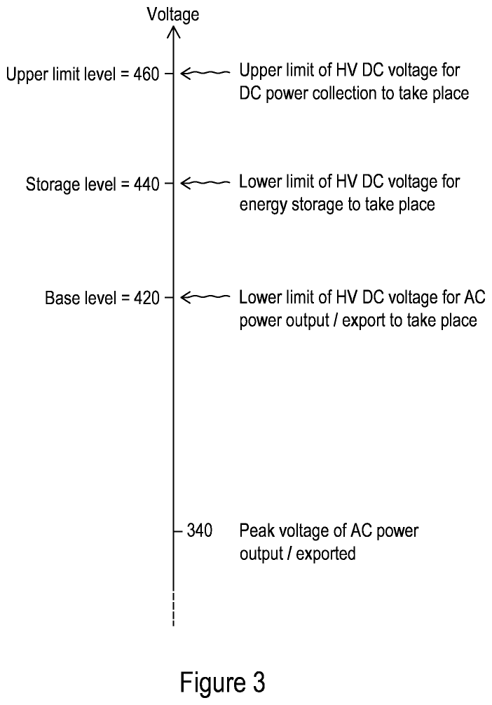

FIG. 3 illustrates how the power conditioning units 15 and the common inverter unit 30 may operate to manage DC power collection and conversion to output AC power responsive to the power available from the photovoltaic panels and to changes in the voltage level of the high voltage DC power coupled between these units using the intermediate cabling. The vertical axis of the figure illustrates typical voltage levels of the high voltage DC which may be used to implement the described functionality, but other particular voltage levels may of course be used.

At the bottom of the figure, a peak voltage of the AC power for output by the common inverter unit 30 to a power grid is shown as 340 V. As light levels at the photovoltaic panels 10 rise and significant levels of power are generated by each panel, for example at least about 10 W, the voltage level of the high voltage DC output by the converter 50 of any of the power conditioning units 15 reaches a base level at which output of AC power by the common inverter unit 30 may begin. This base level voltage could for example be around 420 V, and such a base level may be detected by the inverter control unit 85 of the common inverter unit 30 which then selects an appropriate one or more of the inverter circuits 80 for conversion of these low levels of collected DC power for AC output.

As light levels at the panels increase further, each converter 50 operates to increase the voltage level of the high voltage DC power, which is detected by the inverter control unit 85 which switches in inverter circuits which are more efficient at higher power levels, and if appropriate may switch out inverter circuits which are more efficient at lower power levels. If the DC power collected from the panels reaches a sufficiently high level so that the voltage level of the high voltage DC power meets an upper limit level, illustrated in FIG. 3 as 460 V, then each power conditioning unit may either operate to fade out increases in, apply a ceiling to, or reduce, the DC power passed to the common inverter unit, or to cease supplying any such DC power altogether, for example through suitable control of the maximum power point tracker 40 and/or the converter 50. Typically these effects may be achieved by suitable control of each converter, or stopping the converters altogether. Generally, such converter control may be implemented using active control measures for example in which a control circuit measures the voltage level of the high voltage DC power and provides suitable control signals to or within a converter 50, or using more passive measures in which a converter 50 is adapted to passively or automatically respond to the high voltage DC power as described above.

Above the base level shown in FIG. 3 as 420 V where the level of the high voltage DC acts to signal start of AC power output to the common inverter unit 30, a storage level, shown in FIG. 3 as 440 V, provides a voltage threshold above which the energy storage switch 60 in the power conditioning unit 15 starts to redirect at least a portion of the DC power to a locally connected energy storage unit 70, and/or a further energy storage switch 100 in the common inverter unit starts to redirect at least a portion of the DC power to a locally connected further energy storage unit 95.

In some embodiments, export of AC power by the common inverter unit may cease when the voltage is above the storage level, or may decrease gradually above this level as the voltage approaches the upper limit level.

Although specific embodiments of the invention have been described with reference to the drawings, the skilled person will be aware that variations and modifications may be applied to these embodiments without departing from the scope of the invention defined in the claims. For example although the invention has been described in terms of photovoltaic panels of solar power plant, it could be used with photovoltaic panels in other contexts, or with other renewable energy sources such as wind turbines, or wave or tidal power harvesting devices. Aspects of the invention relate specifically to the described power conditioning units themselves, the common inverter unit itself, and combinations of these aspects, as well as these aspects when implemented in a power system such as a solar power plant.

1. Apparatus for use in a solar power plant which comprises a plurality of photovoltaic panels, the apparatus comprising:
a plurality of power conditioning units, each power conditioning unit being adapted to collect DC power at a panel voltage from each of one or more photovoltaic panels associated with the power conditioning unit, and to pass the DC power to an intermediate power transfer line, such as cabling; and
a common inverter unit adapted to receive the DC power from the plurality of power conditioning units through the intermediate power transfer line and to convert the DC power into AC power for output.

2. The apparatus of claim 1, wherein each power conditioning unit comprises a converter adapted to raise the voltage of the collected DC power above both the peak voltage of the AC power, and above the panel voltage of any of the associated photovoltaic panels, for transmission to the common inverter unit through the intermediate power transfer line as high voltage DC power, the apparatus optionally arranged such that the high voltage DC power has a voltage of at least 350 V, or at least 400 V, when the common inverter unit is outputting said AC power.

3. The apparatus of claim 2, further comprising an energy storage unit coupled to each power conditioning unit, the power conditioning unit being arranged to selectively store at least a portion of the collected DC power, and to selectively release at least a portion of the stored DC power to the common inverter unit through the intermediate power transfer line, the storage of the DC power by the energy storage unit being at substantially the voltage of the high voltage DC power.

4. The apparatus of claim 3, arranged such that selective storing of at least a portion of the collected DC power is controlled dependent on the voltage of the high voltage DC power.

5. The apparatus of claim 2, arranged such that the voltage of the high voltage DC power is dependent upon one or both of: a concurrent demand for AC power for output by the common inverter unit; and concurrently collected DC power from the photovoltaic panels associated with the plurality of power conditioning units.

6. The apparatus of claim 1, wherein each power conditioning unit is arranged to condition the collected DC power using maximum power point tracking to control the panel voltage and/or the output current of each of the one or more photovoltaic panels associated with the power conditioning unit.

7. The apparatus of claim 1, wherein each power conditioning unit is adapted to collect DC power from no more than four associated photovoltaic panels, or wherein each power conditioning unit is adapted to collect DC power from only one associated photovoltaic panel.

8. The apparatus of claim 1, wherein the common inverter unit comprises a plurality of separate inverter circuits, each inverter circuit being arranged to receive a portion of the DC power from the intermediate power transfer line and to convert the received portion of DC power into AC power for output, the common inverter unit being arranged to selectively activate or inactivate one or more of the inverter circuits.

9. The apparatus of claim 8, wherein at least two of the inverter circuits have different efficiency characteristics than each other with respect to the amount of power being converted, and the common inverter unit is arranged to selectively activate and inactivate different ones of the inverter circuits according to the different efficiency characteristics of those inverter circuits and a detected current demand for AC power for output.

10. The apparatus of claim 8, wherein the common inverter unit is arranged to detect a faulty one of the inverter circuits and subsequently to avoid selection of that faulty inverter circuit for conversion of the DC power into AC power for output.

11. The apparatus of claim 1, wherein the common inverter unit is arranged to maintain a measure of reliability of one or more of the inverter circuits, and to limit power loading of one or more of these inverter circuits according to the measure of reliability.

12. The apparatus of claim 1, in which all of the power conditioning units are connected electrically in parallel to the common inverter unit through the intermediate power transfer line.

13. A solar power plant comprising the apparatus of claim 1, the plurality of photovoltaic panels, and the intermediate power transfer line.

14. The solar power plant of claim 13, comprising at least ten of the power conditioning units arranged to pass the high voltage DC power to the common inverter unit through the intermediate power transfer line.

15. The solar power plant of claim 13, wherein the average length of the intermediate power transfer line between each of the power conditioning units and the common inverter unit is at least 10 meters.

16. The solar power plant of claim 13, wherein each power conditioning unit is one of: incorporated within, mounted to, or located within 5 meters of the, or one of the, photovoltaic panels associated with the power conditioning unit.

17. A method of operating a solar power plant comprising:
at each of a plurality of power conditioning units, receiving collected DC power from one or more photovoltaic panels, each power conditioning unit being arranged to collect DC power at a panel voltage and to pass the DC power to intermediate power transfer line, such as cabling;
transmitting the DC power from each of the power conditioning units, through the intermediate power transfer line, to a common inverter unit; and
at the common inverter unit, converting the DC power into AC power with a peak voltage, for output to a power grid.

18. The method of claim 17, further comprising, at each power conditioning unit, raising the voltage of the collected DC power to a higher DC voltage which is above the panel voltage and below the peak voltage, for transmission through the intermediate power transfer line, wherein, optionally, the panel voltage is below 100 V and the higher DC voltage is at least 350 V, or at least 400 V, when the common inverter unit is outputting AC power to the grid.

19. The method of claim 18, further comprising selectively storing at least a portion of the collected DC power, and selectively releasing at least a portion of the stored DC power to the common inverter unit, the actions of storing and releasing being dependent on the level of the higher DC voltage.

20. The method of claim 18, wherein the level of the higher DC voltage is at least partly dependent upon one or both of: a concurrent demand for AC power for output to the power grid; and concurrently collected DC power from the photovoltaic panels.

21. The method of claim 17, in which all of the power conditioning units are connected electrically in parallel to the common inverter unit through the intermediate power transfer line.

22. The method of claim 17, wherein the common inverter unit comprises a plurality of separate inverter circuits, the method comprising controlling each inverter circuit to receive a portion of the DC power from the intermediate power transfer line and to convert the received portion of DC power into AC power for output, and controlling the common inverter unit to selectively activate or inactivate one or more of the inverter circuits.

23. The method of claim 22, wherein at least two of the inverter circuits have different efficiency characteristics than each other with respect to the amount of power being converted, the method comprising detecting a current demand for AC power for output, and controlling the common inverter unit to selectively activate and inactivate different ones of the inverter circuits according to the different efficiency characteristics of those inverter circuits and the current demand for AC power for output.

24. The method of claim 22, comprising detecting a faulty one of the inverter circuits, and avoiding selection of that faulty inverter circuit for conversion of the DC power into AC power for output.

25. The method of claim 17, comprising controlling the common inverter unit to maintain a measure of reliability of one or more of the inverter circuits, and to limit power loading of one or more of these inverter circuits according to the measure of reliability.
